(19) United States
(12) Patent Application Publication
(10) Pub. No.: US 2021/0391759 A1
(43) Pub. Date: Dec. 16, 2021

(54) POSITION DETECTION SYSTEM AND WIRELESS POWER TRANSMISSION SYSTEM

(71) Applicant: TDK CORPORATION, Tokyo (JP)

(72) Inventor: Daichi MORI, Tokyo (JP)

(73) Assignee: TDK CORPORATION, Tokyo (JP)

(21) Appl. No.: 17/329,268

(22) Filed: May 25, 2021

(30) Foreign Application Priority Data
Jun. 11, 2020 (JP) 2020-101560

(51) Int. Cl. H02J 50/90; H02J 50/10; B60L 53/12

(52) U.S. Cl. CPC H02J 50/90; H01F 27/24; B60L 53/12; H02J 50/10

(57) ABSTRACT

Provided is a position detection system capable of detecting a position with high accuracy when position detection is performed using an antenna on a transmission side and an antenna on a reception side. In the position detection system, at least one of a transmission antenna and a reception antenna is a multi-axis antenna including a first winding portion formed by winding a first conducting wire and a second winding portion formed by winding a second conducting wire. An axial direction of a first winding axis of the first winding portion and an axial direction of a second winding axis of the second winding portion are two directions different from each other. The first winding portion and the second winding portion are electrically connected to each other.

### CROSS-REFERENCE TO RELATED APPLICATION

Priority is claimed on Japanese Patent Application No. 2020-101560, filed Jun. 11, 2020, the content of which is incorporated herein by reference.

### BACKGROUND OF THE INVENTION

### Field of the Invention

The present disclosure relates to a position detection system and a wireless power transmission system.

### Description of Related Art

At present, the development of wireless power transmission devices for wirelessly transmitting (feeding) electric power to a moving object and a wireless power reception device is in progress.

A magnetic field resonance method is mainstream for a wireless power transmission method. In the magnetic field resonance method, a power transmission coil is provided on a device on a power transmission side and a power reception coil is provided on a device on a power reception side and electric power is wirelessly transmitted from the power transmission coil to the power reception coil.

It is necessary to accurately align a central axis of the power transmission coil with a central axis of the power reception coil during power transmission so that the above-described wireless power transmission is efficiently performed. Also, it is necessary to accurately detect relative positions of the power transmission coil and the power reception coil so that the above-described central axes are aligned with high accuracy.

Position detection in a wireless power transmission system is performed, for example, by transmitting and receiving radio waves of a low frequency (LF) band.

Also, the position detection in the wireless power transmission system is performed using a bar antenna on the transmission side and a bar antenna on the reception side. The bar antenna is a ferrite bar antenna or the like.

### PATENT DOCUMENTS

[Patent Document 1] PCT International Publication No. WO 2016/209514

### SUMMARY OF THE INVENTION

However, in principle, the bar antenna on the reception side has a region called a zero point (or a null point) at which the reception strength decreases. Thus, when the bar antenna on the transmission side is present in the above region, the accuracy of position detection may be lowered due to the decrease in the reception strength of the bar antenna on the reception side.

Also, for example, even if two transmission antennas and four reception antennas are used to mitigate an influence of the zero point, a region where the zero points of the plurality of reception antennas overlap is formed and the accuracy of position detection may be lowered.

Patent Document 1 discloses a device for determining relative positions of a wireless power transmitter and a wireless power receiver with respect to wireless power feeding of an electric vehicle (see the summary of Patent Document 1 and the like). The device includes a plurality of sense coils. Each sense coil generates a voltage signal according to a first alternating magnetic field that oscillates at two frequencies and a second alternating magnetic field that oscillates at at least one frequency. In the device, a processor determines the relative positions of the wireless power transmitter and the wireless power receiver on the basis of the voltage signal from each sense coil.

However, because the antenna described in Patent Document 1 is similar to a configuration in which each of three-axis windings is independent and a plurality of bar antennas are used with respect to a zero point of an antenna, data that has been acquired includes data of a zero point at which the reception strength is lowered and consequently the accuracy of position detection may be lowered.

Although the antenna on the reception side has been described above, the same is true for the transmission strength from the antenna on the transmission side.

The present disclosure has been made in consideration of the above circumstances and an objective of the present disclosure is to provide a position detection system and a wireless power transmission system capable of detecting a position with high accuracy when position detection is performed using an antenna on a transmission side and an antenna on a reception side.

According to an aspect of the present disclosure, there is provided a position detection system for a wireless power transmission system for wirelessly transmitting electric power from a power transmission coil of a wireless power transmission device to a power reception coil of a wireless power reception device, the position detection system including: at least one transmission antenna provided in one of the wireless power transmission device and the wireless power reception device and configured to transmit radio waves; at least one reception antenna provided in the other of the wireless power transmission device and the wireless power reception device and configured to receive the radio waves; a radio wave detection unit configured to detect strength of the radio waves received by the reception antenna, and a position detection unit configured to detect a relative position between the power transmission coil and the power reception coil on the basis of the strength detected by the radio wave detection unit, wherein at least one of the transmission antenna and the reception antenna is a multi-axis antenna including a first winding portion formed by winding a first conducting wire and a second winding portion formed by winding a second conducting wire, wherein an axial direction of a first winding axis of the first winding portion and an axial direction of a second winding axis of the second winding portion are two different directions, and wherein the first winding portion and the second winding portion are electrically connected to each other.

According to an aspect of the present disclosure, there is provided a wireless power transmission system including the above-described position detection system.

According to the position detection system and the wireless power transmission system related to the present disclosure, it is possible to detect a position with high accuracy when position detection is performed using an antenna on a transmission side and an antenna on a reception side.

### BRIEF DESCRIPTION OF THE DRAWINGS

FIG. 1 is a diagram showing a schematic configuration of a wireless power transmission system according to an embodiment.

FIG. 2 is a diagram showing an example of an arrangement of a transmission antenna and a reception antenna according to an embodiment.

FIG. 3 is a diagram showing another example of an arrangement of a transmission antenna according to an embodiment.

FIG. 4 is a diagram showing a schematic configuration of a multi-axis antenna according to an embodiment (a first embodiment).

FIG. 5 is a diagram showing a schematic configuration of a bent portion in the multi-axis antenna according to the embodiment (the first embodiment).

FIG. 6 is a diagram showing a schematic configuration of a multi-axis antenna according to a modified example of the embodiment (the first embodiment).

FIG. 7 is a diagram showing a schematic configuration of a multi-axis antenna according to an embodiment (a second embodiment).

FIG. 8 is a diagram showing a schematic configuration of a multi-axis antenna according to an embodiment (a third embodiment).

FIG. 9 is a diagram showing a schematic configuration of a multi-axis antenna according to an embodiment (a fourth embodiment).

### DETAILED DESCRIPTION OF THE INVENTION

Hereinafter, embodiments of the present disclosure will be described with reference to the drawings.

### [Wireless Power Transmission System]

In the present embodiment, for convenience of description, wirelessly transmitting electric power will be described as wireless power transmission.

Also, in the present embodiment, a conductor, which transmits an electrical signal corresponding to direct current (DC) power or an electrical signal corresponding to alternating current (AC) power, will be described as a transmission line. The transmission line is, for example, a conductor printed on a substrate. Also, the transmission line may be a conducting wire or the like instead of such a conductor. The conducting wire is a conductor formed in a linear shape.

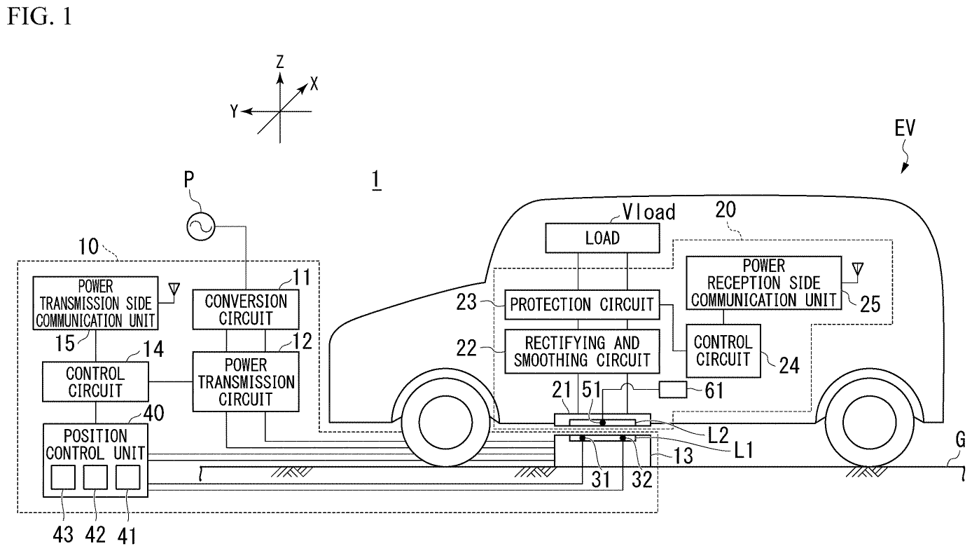

FIG. 1 is a diagram showing a schematic configuration of a wireless power transmission system 1 according to an embodiment. In FIG. 1, for convenience of description, XYZ coordinate axes, which are three-dimensional orthogonal coordinate axes are shown.

In the present embodiment, a direction of a Z-axis is a height direction and a direction from a negative component to a positive component of the Z-axis corresponds to an upward direction.

Also, in the present embodiment, a ground surface is a plane parallel to an XY plane. In the present embodiment, for the simplification of description, the ground surface will be described as a flat surface.

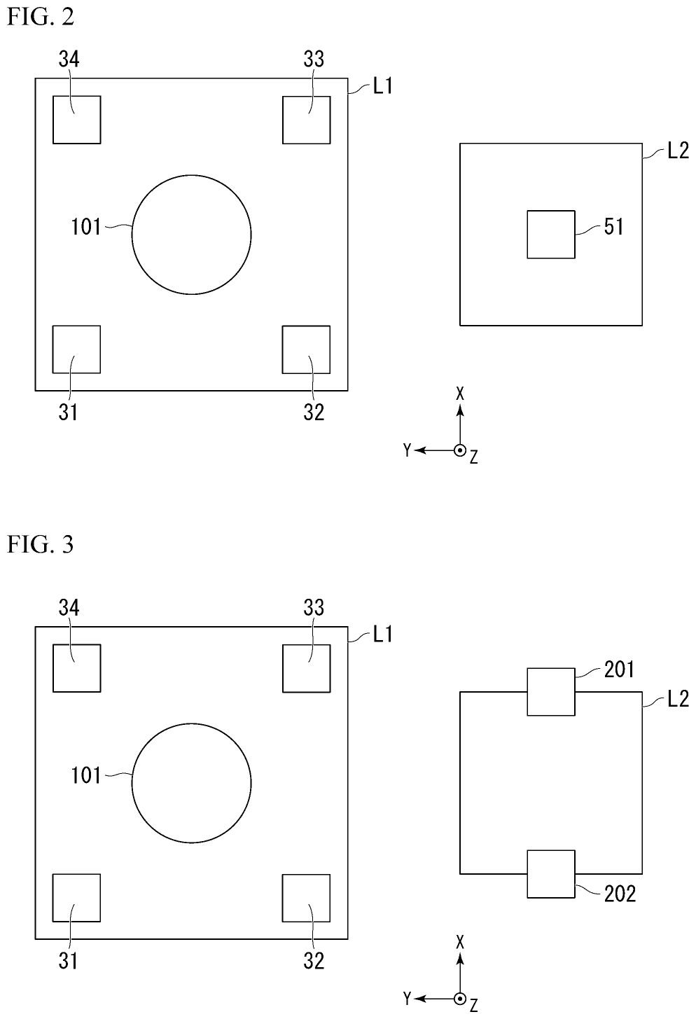

FIG. 2 is a diagram showing an example of the arrangement of a transmission antenna 51 and reception antennas 31 to 34 according to the embodiment. In FIG. 2, XYZ coordinate axes that are the same as those shown in FIG. 1 are shown for convenience of description.

Hereinafter, a configuration of the wireless power transmission system 1 will be described with reference to FIGS. 1 and 2.

The wireless power transmission system 1 includes a wireless power transmission device 10 and a wireless power reception device 20.

The wireless power transmission device 10 includes a conversion circuit 11, a power transmission circuit 12, a power transmission coil unit 13, a control circuit 14, a power transmission side communication unit 15, and a position control unit 40. On the other hand, the wireless power reception device 20 includes a power reception coil unit 21, a rectifying and smoothing circuit 22, a protection circuit 23, a control circuit 24, a power reception side communication unit 25, and a communication control unit 61. The wireless power reception device 20 can be connected to a load Vload. In the example shown in FIG. 1, the wireless power reception device 20 is connected to the load Vload. Also, the wireless power reception device 20 may be configured to include the load Vload.

Here, the power transmission coil unit may be called, for example, a power transmission pad. Also, the power reception coil unit may be called, for example, a power reception pad.

The wireless power transmission device 10 will be described.

The conversion circuit 11 is, for example, an AC/DC converter that is connected to an external commercial power supply P and converts an AC voltage input from the commercial power supply P into a desired DC voltage. The conversion circuit 11 is connected to the power transmission circuit 12. The conversion circuit 11 supplies the DC voltage obtained by converting the AC voltage to the power transmission circuit 12.

Also, the conversion circuit 11 may be any device that outputs the DC voltage to the power transmission circuit 12. For example, the conversion circuit 11 may be a conversion circuit in which a rectifying and smoothing circuit that rectifies the AC voltage and converts the AC voltage into the DC voltage and a power factor correction (PFC) circuit that improves a power factor are combined, a conversion circuit in which the rectifying and smoothing circuit and a switching circuit such as a switching converter are combined, or another conversion circuit that outputs the DC voltage to the power transmission circuit 12.

The power transmission circuit 12 converts the DC voltage supplied from the conversion circuit 11 into the AC voltage. For example, the power transmission circuit 12 includes an inverter including a switching circuit in which a plurality of switching elements are bridge-connected. The power transmission circuit 12 is connected to the power transmission coil unit 13. The power transmission circuit 12 supplies the power transmission coil unit 13 with an AC voltage whose drive frequency is controlled on the basis of a resonant frequency of the power transmission side resonance circuit provided in the power transmission coil unit 13.

The power transmission coil unit 13 includes, for example, an LC resonance circuit including a power transmission coil L1 and a capacitor (not shown in FIG. 1) as a power transmission side resonance circuit. In this case, the power transmission coil unit 13 can adjust the resonant frequency of the power transmission side resonance circuit by adjusting the capacitance of the capacitor. The wireless power transmission device 10 performs wireless power transmission of a magnetic field resonance method of causing the resonant frequency of the power transmission side resonance circuit to be close (or identical) to the resonant frequency of the power reception side resonance circuit provided in the power reception coil unit 21. For example, the capacitor may include a capacitor connected in series with the power transmission coil L1, may include a capacitor connected in series with the power transmission coil L1 and a capacitor connected in parallel to the power transmission coil L1, or may be configured according to another form.

As described above, at least one of the capacitors provided in the power transmission side resonance circuit of the power transmission coil unit 13 can be replaced with a capacitor module. As a result of this, at least one of miniaturization, manufacturing cost reduction, and simplification of a wiring structure can be implemented for the power transmission side resonance circuit.

Also, the power transmission coil unit 13 may be configured to include another resonance circuit including the power transmission coil L1 as the power transmission side resonance circuit instead of the LC resonance circuit. Also, the power transmission coil unit 13 may be configured to include another circuit, another circuit element, or the like in addition to the power transmission side resonance circuit. Also, the power transmission coil unit 13 may have a configuration including a magnetic material that enhances the magnetic coupling between the power transmission coil L1 and the power reception coil L2, an electromagnetic shield (for example, a metal plate or the like) that limits external leakage of the magnetic field generated by the power transmission coil L1, or the like. Also, in the above cases, in the power transmission coil unit 13, at least one of the capacitors provided in the power transmission side resonance circuit can be replaced with a capacitor module.

The power transmission coil L1 is, for example, a coil for wireless power transmission in which a Litz wire made of copper, aluminum, or the like is spirally wound. The power transmission coil L1 of the present embodiment is installed on the ground G or embedded in the ground G so as to face the lower side of the floor of the electric vehicle EV. Hereinafter, a case in which the power transmission coil L1 (i.e., the power transmission coil unit 13) is installed on the ground G together with the power transmission circuit 12 will be described as an example.

The control circuit 14 controls the wireless power transmission device 10. The control circuit 14 controls the power transmission side communication unit 15 so that the power transmission side communication unit 15 is allowed to transmit and receive various types of information to and from the wireless power reception device 20. For example, the control circuit 14 receives power information representing the electric power received by the wireless power reception device 20 from the wireless power reception device 20 using the power transmission side communication unit 15. Also, voltage information representing a voltage may be used or current information representing an electric current may be used instead of the power information.

Also, the control circuit 14 controls the AC voltage supplied by the power transmission circuit 12 to the power transmission coil L1 on the basis of the power information received from the wireless power reception device 20 via the power transmission side communication unit 15. Specifically, the control circuit 14 calculates an amount of electric power to be transmitted to the wireless power reception device 20 in accordance with the power information. The control circuit 14 controls a drive frequency of the inverter provided in the power transmission circuit 12, a duty ratio of the inverter, and the like in accordance with the calculated amount of power transmission. Thereby, the control circuit 14 controls the AC voltage supplied by the power transmission circuit 12 to the power transmission coil L1. That is, the control circuit 14 adjusts the AC voltage supplied by the power transmission circuit 12 to the power transmission coil L1 according to feedback control based on the power information. For example, the control circuit 14 performs PID control as feedback control for adjusting the AC voltage. Also, the control circuit 14 may be configured to perform control other than PID control as feedback control for adjusting the AC voltage.

The power transmission side communication unit 15 is a communication circuit (or a communication device) that transmits/receives signals according to wireless communication, optical communication, electromagnetic induction, sound, vibration, or the like. The power transmission side communication unit 15 transmits and receives various types of information to and from the wireless power reception device 20 in accordance with signals from the control circuit 14.

The position control unit 40 and the reception antennas 31 to 34 provided in the power transmission coil unit 13 will be described below.

Also, in FIG. 1, the reception antennas 33 and 34 (not shown) among the reception antennas 31 to 34 are present on the back side when viewed from the direction shown in FIG. 1.

In the present embodiment, the wireless power transmission system 1 includes a position detection system that detects the relative positions of the power transmission coil L1 and the power reception coil L2. In the present embodiment, the position detection system includes a communication control unit 61, a transmission antenna 51, the position control unit 40, and the reception antennas 31 to 34.

The wireless power reception device 20 will be described.

The power reception coil unit 21 includes, for example, an LC resonance circuit having a capacitor (not shown in FIG. 1) together with the power reception coil L2 as a power reception side resonance circuit. In this case, the power reception coil unit 21 can adjust the resonant frequency of the power reception side resonance circuit by adjusting the capacitance of the capacitor. The wireless power reception device 20 performs wireless power transmission of a magnetic field resonance method of causing the resonant frequency of the power reception side resonance circuit to be close (or identical) to the resonant frequency of the power transmission side resonance circuit. For example, the capacitor may include a capacitor connected in series with the power reception coil L2, may include a capacitor connected in series with the power reception coil L2 and a capacitor connected in parallel to the power reception coil L2, or may be configured according to another form.

As described above, at least one of the capacitors provided in the power reception side resonance circuit of the power reception coil unit 21 can be replaced with a capacitor module as in the power transmission side resonance circuit of the power transmission coil unit 13. As a result of this, at least one of miniaturization, manufacturing cost reduction, and simplification of a wiring structure can be implemented for the power reception side resonance circuit.

Also, the power reception coil unit 21 may be configured to include another resonance circuit including the power reception coil L2 as the power reception side resonance circuit instead of the LC resonance circuit. Also, the power reception coil unit 21 may be configured to include another circuit, another circuit element, or the like in addition to the power reception side resonance circuit. Also, the power reception coil unit 21 may be configured to include a magnetic material that enhances the magnetic coupling between the power transmission coil L1 and the power reception coil L2, and an electromagnetic shield (for example, a metal plate or the like) that limits external leakage of the magnetic field generated by the power reception coil L2. Also, in the above cases, in the power reception coil unit 21, at least one of the capacitors provided in the power reception side resonance circuit can be replaced with a capacitor module.

The rectifying and smoothing circuit 22 is connected to the power reception coil unit 21, rectifies an AC voltage supplied from the power reception coil L2, and converts the AC voltage into a DC voltage. The rectifying and smoothing circuit 22 can be connected to the load Vload. In the example shown in FIG. 1, the rectifying and smoothing circuit 22 is connected to the load Vload via the protection circuit 23. When the rectifying and smoothing circuit 22 is connected to the load Vload, the rectifying and smoothing circuit 22 supplies DC power obtained through the conversion to the load Vload. Also, in the wireless power reception device 20, when the rectifying and smoothing circuit 22 is connected to the load Vload, the rectifying and smoothing circuit 22 may be configured to be connected to the load Vload via a charging circuit instead of the protection circuit 23 or may be configured to be connected to the load Vload via a charging circuit in addition to the protection circuit 23.

Here, when the load Vload is connected to the rectifying and smoothing circuit 22, a DC voltage is supplied from the rectifying and smoothing circuit 22. For example, the load Vload is a battery mounted on an electric vehicle EV, a motor mounted on an electric vehicle EV, or the like. The load Vload is a resistance load whose equivalent resistance value changes with time according to a demand state (a storage state or a consumption state) of electric power. Also, in the wireless power reception device 20, the load Vload may be another load to which the DC voltage supplied from the rectifying and smoothing circuit 22 is supplied instead of the battery, the motor, and the like.

The protection circuit 23 prevents a malfunction from occurring due to the supply of the voltage or the electric current to the load Vload and protects the load Vload when the state of the wireless power reception device 20 becomes a state in which a voltage or an electric current of an unintended magnitude is likely to be supplied to the load Vload (for example, an overvoltage state). For example, the protection circuit 23 includes a switching element that short-circuits terminals of the power reception coil L2. The protection circuit 23 switches the state of the switching element between on and off in accordance with a drive signal from the control circuit 24. Also, the wireless power reception device 20 may be configured without the protection circuit 23.

The control circuit 24 controls the wireless power reception device 20. The control circuit 24 controls the power reception side communication unit 25 so that the power reception side communication unit 25 is allowed to transmit and receive various types of information to and from the wireless power transmission device 10. For example, the control circuit 24 transmits power information representing electric power received by the wireless power reception device 20 to the wireless power transmission device 10 using the power reception side communication unit 25.

Also, the control circuit 24 outputs the drive signal to the protection circuit 23 and protects the load Vload when the state of the wireless power reception device 20 becomes a state in which a voltage or an electric current of an unintended magnitude is likely to be supplied to the load Vload.

The power reception side communication unit 25 is a communication circuit (or a communication device) that transmits and receives signals according to wireless communication, optical communication, electromagnetic induction, sound, vibration, or the like. The power reception side communication unit 25 transmits and receives various types of information to and from the wireless power transmission device 10 in accordance with signals from the control circuit 24.

The communication control unit 61 and the transmission antenna 51 provided in the power reception coil unit 21 will be described below.

In the present embodiment, in the wireless power transmission system 1, electric power is transmitted from the wireless power transmission device 10 to the wireless power reception device 20 according to wireless power transmission. More specifically, in the wireless power transmission system 1, electric power is transmitted according to wireless power transmission from the power transmission coil L1 provided in the wireless power transmission device 10 to the power reception coil L2 provided in the wireless power reception device 20. The wireless power transmission system 1 performs wireless power transmission using, for example, a magnetic field resonance method. The wireless power transmission system 1 may be configured to perform wireless power transmission using another method instead of the magnetic field resonance method.

In the present embodiment, as an example, a case in which the wireless power transmission system 1 is applied to a system that charges a battery (a secondary battery) mounted on an electric vehicle EV according to wireless power transmission is shown as shown in FIG. 1. An electric vehicle EV is an electric vehicle (a moving body) that travels by driving a motor using electric power with which a battery is charged. In the example shown in FIG. 1, the wireless power transmission system 1 includes the wireless power transmission device 10 installed on the ground G on a charging equipment side and the wireless power reception device 20 mounted on the electric vehicle EV. Also, the wireless power transmission system 1 may have a configuration applied to another device, another system, or the like, instead of the configuration applied to the system.

Here, in wireless power transmission in the magnetic field resonance method, the wireless power transmission system 1 causes the resonant frequency of a power transmission side resonance circuit (not shown) (provided in the power transmission coil unit 13 in the example shown in FIG. 1) provided in the wireless power transmission device 10 to be close (identical) to the resonant frequency of a power reception side resonance circuit (not shown) (provided in the power reception coil unit 21 in the example shown in FIG. 1) provided in the wireless power reception device 20, applies a high-frequency current and voltage near the resonant frequency to the power transmission coil unit 13, and wirelessly transmits (supplies) electric power to the power reception coil unit 21 that is electromagnetically resonated.

Thus, the wireless power transmission system 1 of the present embodiment can perform charging based on wireless power transmission with respect to the battery mounted on the electric vehicle EV while wirelessly transmitting the electric power supplied from the charging equipment side to the electric vehicle EV without connecting to a charging cable.

### [Position Detection System for Wireless Power Transmission System]

An example of the arrangement of the transmission antenna 51 and the reception antennas 31 to 34 will be described with reference to FIG. 2.

In FIG. 2, the power transmission coil L1, the reception antennas 31 to 34, the power reception coil L2, and the transmission antenna 51 are shown.

In the present example, the surface of the power transmission coil L1 is a surface parallel to (or substantially parallel to) the XY plane.

The surface of the power transmission coil L1 has a shape linearly symmetrical with respect to a line parallel to the X-axis passing through the center of the surface. Likewise, the surface of the power transmission coil L1 has a shape linearly symmetrical with respect to a line parallel to the Y-axis passing through the center of the surface.

In FIG. 2, a state in which the power transmission coil L1 and the power reception coil L2 do not overlap when viewed from a line of sight parallel to the Z-axis is shown. The above state is, for example, a state before the power reception coil L2 provided in the electric vehicle EV reaches a position above the power transmission coil L1 or a state after the power reception coil L2 provided in the electric vehicle EV is moved from above the power transmission coil L1.

The four reception antennas 31 to 34 are disposed at predetermined intervals on peripheral edges of the power transmission coil unit 13 and the power transmission coil L1. More specifically, the four reception antennas 31 to 34 are respectively disposed in the vicinity of four corners of the surface of the power transmission coil L1. Also, the four reception antennas 31 to 34 are disposed inside the surface of the power transmission coil L1. The four reception antennas 31 to 34 may be disposed, for example, on an edge of a housing of the power transmission coil unit 13.

As described above, in the present embodiment, the four reception antennas 31 to 34 are disposed at predetermined intervals in the region surrounding the center of the surface of the power transmission coil L1 in a rotational direction in which the center is the central axis.

Also, as another example of the configuration, one or both of the transmission antenna 51 and the reception antennas 31 to 34 may be disposed at other positions instead of the transmission antenna 51 and the reception antennas 31 to 34 being disposed in the power reception coil unit 21 and the power transmission coil unit 13. In the case of the present embodiment, for example, the transmission antenna 51 may be disposed on a vehicle body of the electric vehicle EV or the reception antennas 31 to 34 may be disposed on the ground. Also, in the above arrangement, a configuration in which the relative positional relationship between the power transmission coil L1 and the reception antennas 31 to 34 is determined and the relative positional relationship between the power reception coil L2 and the transmission antenna 51 is determined can be adopted.

In the present embodiment, four reception antennas 31 to 34, which are a plurality of reception antennas, are disposed at different positions.

In the above arrangement, it is possible to identify relative positional relationships between the transmission antenna 51 and the reception antennas 31 to 34 according to a combination of strengths of a plurality of radio waves when the signal transmitted from the transmission antenna 51 is received by each of the plurality of reception antennas 31 to 34. Also, the relative positional relationship between the power transmission coil L1 and the reception antennas 31 to 34 is determined and the relative positional relationship between the power reception coil L2 and the transmission antenna 51 is determined, so that relative positional relationship between the power transmission coil L1 and the power reception coil L2 can be identified.

The four reception antennas 31 to 34 are disposed at linearly-symmetrical positions and orientations with respect to a line parallel to the X-axis passing through the center of the surface of the power transmission coil L1. Likewise, the four reception antennas 31 to 34 are disposed at linearly-symmetrical positions and orientations with respect to a line parallel to the Y-axis passing through the center of the surface of the power transmission coil L1.

In the present embodiment, the four reception antennas 31 to 34 are multi-axis antennas, which will be described below, and are antennas having the same configuration.

In the present example, all the reception antennas 31 to 34 are disposed on a surface parallel to a surface (a coil surface) of the power transmission coil L1 so as to have the same orientation with respect to the XYZ coordinate axes.

Also, the relative positional relationship of the plurality of reception antennas 31 to 34 may be determined by various arrangement conditions.

Here, it is often easier to ascertain the relative positions of the transmission antenna 51 and the reception antennas 31 to 34 when the distance between the adjacent reception antennas 31 to 34 is large. In the present embodiment, for example, a large distance between the adjacent reception antennas 31 to 34 is ensured by disposing the reception antennas 31 to 34 at the four corners of the power transmission coil unit 13.

Here, as another example of the configuration, a configuration in which at least one reception antenna is disposed to have a different orientation with respect to the XYZ coordinate axes within a surface parallel to a surface (a coil surface) of the power transmission coil L1 may be used.

Also, in the present example, the surface of the power reception coil L2 becomes a surface parallel to (or substantially parallel to) the XY plane.

The surface of the power reception coil L2 has a shape linearly symmetrical with respect to a line parallel to the X-axis passing through the center of the surface. Likewise, the surface of the power reception coil L2 has a shape linearly symmetrical with respect to a line parallel to the Y-axis passing through the center of the surface.

In the present example, the surface of the power reception coil L2 is smaller than the surface of the power transmission coil L1 and has a size capable of being included in the surface of the power transmission coil L1 when the centers of both are aligned and overlap.

One transmission antenna 51 is disposed at the center (or near the center) of the surface of the power reception coil L2.

In the present embodiment, the transmission antenna 51 is a multi-axis antenna to be described below.

In the present example, the transmission antenna 51 is disposed within a surface parallel to a surface (a coil surface) of the power reception coil L2 so as to have the same orientation as the reception antennas 31 to 34 with respect to the XYZ coordinate axes. Also, as another example of the configuration, the transmission antenna 51 may be disposed in another orientation.

A position detection process will be described with reference to FIGS. 1 and 2.

The communication control unit 61 causes radio waves to be transmitted from the transmission antenna 51. Here, the frequency and strength of the radio waves may be arbitrary, and for example, the radio waves may be received by the reception antennas 31 to 34. As the frequency of the radio waves, the frequency of the LF band may be used, but other frequencies may be used. Also, the waveform of the radio waves may be arbitrary, and for example, a sine wave waveform or the like may be used.

The communication control unit 61 may, for example, oscillate a radio wave signal, amplify the radio wave signal, or the like.

Although the communication control unit 61 is separate from the control circuit 24 in the present embodiment, the communication control unit 61 may be integrally configured with the control circuit 24 as another example of the configuration. Also, for example, the communication control unit 61 and the transmission antenna 51 may be integrally configured.

In the present embodiment, the transmission antenna 51 substantially transmits radio waves to the reception antennas 31 to 34.

Each of the reception antennas 31 to 34 receives the radio waves transmitted from the transmission antenna 51. Each of the reception antennas 31 to 34 transmits a signal of the received radio waves (a radio wave signal) to the position control unit 40 via a wired circuit.

The position control unit 40 includes a radio wave detection unit 41, a position detection unit 42, and a storage unit 43.

The radio wave detection unit 41 receives radio wave signals transmitted from the reception antennas 31 to 34 to the position control unit 40, and detects strengths of the radio waves received by the reception antennas 31 to 34 on the basis of the radio wave signals.

Also, for example, the radio wave detection unit 41 may perform amplification and the like on the radio wave signals received from the reception antennas 31 to 34 or the like.

The position detection unit 42 detects relative positions of the power transmission coil L1 and the power reception coil L2 on the basis of the strengths of the radio wave signals received from the reception antennas 31 to 34 detected by the radio wave detection unit 41.

Here, in the present embodiment, the relative positions of the power transmission coil L1 and the reception antennas 31 to 34 are fixed and the relative positions of the power reception coil L2 and the transmission antenna 51 are fixed. Thereby, if the relative positions of the reception antennas 31 to 34 and the transmission antenna 51 are ascertained, the relative positions of the power transmission coil L1 and the power reception coil L2 can be ascertained.

In the present embodiment, a relationship between the strength of the radio wave signal received from each of the reception antennas 31 to 34 and the relative position between the power transmission coil L1 and the power reception coil L2 is measured and acquired in advance.

The storage unit 43 can store various types of information. In the present embodiment, information representing relationships between the strength of the radio wave signal received from each of the reception antennas 31 to 34 and the relative positions of the power transmission coil L1 and the power reception coil L2 is stored.

The position detection unit 42 detects the relative positions of the power transmission coil L1 and the power reception coil L2 on the basis of the strength of the radio wave signal received from each of the reception antennas 31 to 34 detected by the radio wave detection unit 41 with reference to the information representing the relationship stored in the storage unit 43.

As another example, the position detection unit 42 may detect the relative positions of the power transmission coil L1 and the power reception coil L2 by calculating a predetermined mathematical formula on the basis of the strength of the radio wave signal received from each of the reception antennas 31 to 34 detected by the radio wave detection unit 41. In this case, for example, information of the mathematical formula may be stored in the storage unit 43.

Here, although a case in which the position detection unit 42 detects the relative position between the power transmission coil L1 and the power reception coil L2 on the basis of the information stored in the storage unit 43 is shown in the present embodiment, the position detection unit 42 may refer to information stored in an external server or the like of the wireless power transmission device 10 via a network such as the Internet and detect the relative positions of the power transmission coil L1 and the power reception coil L2 on the basis of the information as another example of the configuration.

Although the position control unit 40 is separate from the control circuit 14 in the present embodiment, the position control unit 40 may be integrally configured with the control circuit 14 as another example of the configuration. Also, for example, the position control unit 40 and the reception antennas 31 to 34 may be integrally configured.

Here, although the transmission antenna 51 and the reception antennas 31 to 34 use multi-axis antennas having the same configuration in the present embodiment, multi-axis antennas having different configurations may be used in the transmission antenna 51 and the reception antennas 31 to 34.

### [Communication of Information by Transmission Antenna and Reception Antenna]

Communication of any information may be performed between the transmission antenna 51 and the reception antennas 31 to 34.

In the present embodiment, the wireless power reception device 20 may transmit unique information of the own device (the wireless power reception device 20) by controlling the number of transmission pulses or a transmission pulse width using the transmission antenna 51. In this case, the wireless power transmission device 10 receives the unique information using the reception antennas 31 to 34.

Also, for example, either one of control of the number of transmission pulses and control of the transmission pulse width may be performed.

As another example of the configuration, when a transmission antenna is provided in the wireless power transmission device 10, the wireless power transmission device 10 may transmit unique information of the own device (the wireless power transmission device 10) by controlling the number of transmission pulses or the transmission pulse width using the transmission antenna. In this case, the wireless power reception device 20 receives unique information using the reception antennas 31 to 34.

Also, for example, either one of control of the number of transmission pulses and control of the transmission pulse width may be performed.

Here, various information may be used as the unique information transmitted from one device of the wireless power reception device 20 and the wireless power transmission device 10 to the other device. As the unique information, for example, one or more of an ID for identifying the own device (the one device) (for example, a device ID), information such as a vehicle height related to a vehicle equipped with the own device (the one device), information of an electric power standard related to the wireless power transmission, information such as a shape of the coil or an installation position of the coil in the own device (the one device), and the like may be used.

Also, in a configuration in which unique information is transmitted from one device to the other device, for example, the information stored in association with the identification information (for example, a device ID) of the one device in the other device may not be transmitted from the one device to the other device. In this case, the other device can identify the information on the basis of the identification information received from the one device.

Here, when the one device includes a plurality of transmission antennas, the communication of information may be performed using, for example, one or more transmission antennas among the plurality of transmission antennas.

Also, when the other device includes a plurality of reception antennas, the communication of information may be performed using, for example, one or more reception antennas among the plurality of reception antennas.

### [Other Examples of Arrangement of Transmission Antenna]

FIG. 3 is a diagram showing another example of the arrangement of the transmission antennas 201 to 202 according to the embodiment. In FIG. 3, XYZ coordinate axes that are the same as those shown in FIG. 1 are shown for convenience of description.

In FIG. 3, the power transmission coil L1, the four reception antennas 31 to 34, the power reception coil L2, and the two transmission antennas 201 to 202 are shown.

Here, the components of the power transmission coil L1 and the four reception antennas 31 to 34 are similar to the components described with reference to FIGS. 1 and 2 and are denoted by the same reference signs.

In the present example, the power reception coil L2 and the two transmission antennas 201 to 202 are used in place of the power reception coil L2 and one transmission antenna 51 shown in FIGS. 1 and 2.

In FIG. 3, a state in which the power transmission coil L1 and the power reception coil L2 do not overlap when viewed from a line of sight parallel to the Z-axis is shown. The above state is, for example, a state before the power reception coil L2 provided in the electric vehicle EV reaches a position above the power transmission coil L1 or a state after the power reception coil L2 provided in the electric vehicle EV is moved from above the power transmission coil L1.

The transmission antennas 201 to 202 will be described.

In the present example, the power reception coil unit (another example of the power reception coil unit 21) includes two transmission antennas 201 to 202.

In the present example, the two transmission antennas 201 to 202 are respectively disposed on two opposite sides of the power reception coil unit when viewed from a line of sight parallel to the Z-axis.

In the example of FIG. 3, the two transmission antennas 201 to 202 are respectively disposed on two sides parallel to the Y-axis of the power reception coil unit when viewed from a line of sight parallel to the Z-axis.

In the present embodiment, the transmission antennas 201 to 202 are multi-axis antennas, which will be described below, and are antennas having the same configuration.

In the present example, all the transmission antennas 201 to 202 are disposed within a surface parallel to a surface (a coil surface) of the power reception coil L2 so as to have the same orientation with respect to the XYZ coordinate axes.

Also, the relative positional relationship between the plurality of transmission antennas 201 to 202 may be determined according to various arrangement conditions.

In the present example, the power reception coil unit is disposed in the electric vehicle EV so that a direction of a side provided in the transmission antennas 201 to 202 (a direction parallel to the Y-axis) is identical to a direction in which the front and the rear of the electric vehicle FV are connected.

Here, although multi-axis antennas having the same configuration are used in the transmission antennas 201 to 202 and the reception antennas 31 to 34 in the present embodiment, multi-axis antennas having different configurations may be used in the transmission antennas 201 to 202 and the reception antennas 31 to 34 as another example of the configuration.

### [Multi-Axis Antenna]

Hereinafter, the multi-axis antenna according to the embodiment will be described.

### First Embodiment

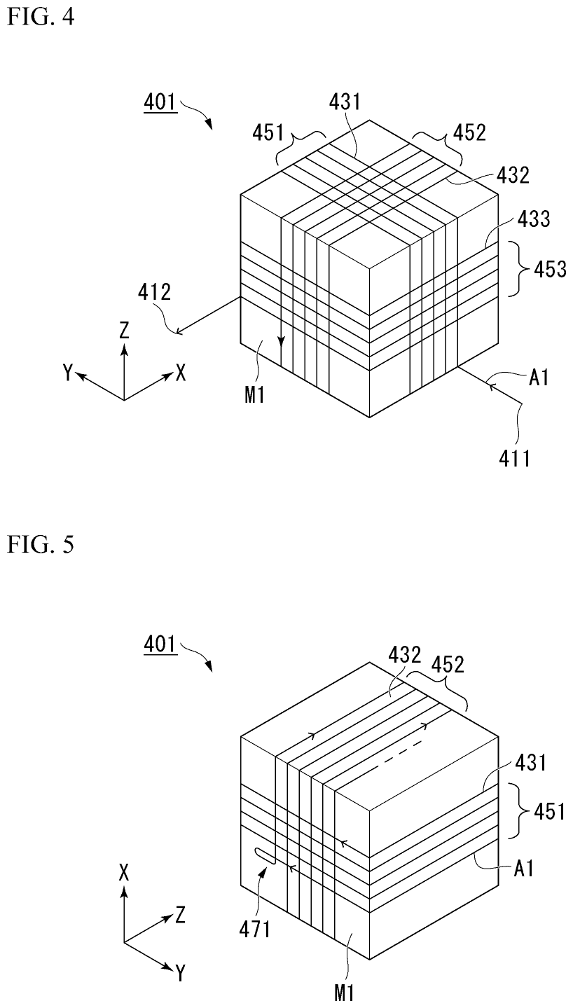

FIG. 4 is a diagram showing a schematic configuration of a multi-axis antenna 401 according to an embodiment (a first embodiment).

In FIG. 4, XYZ coordinate axes, which are three-dimensional orthogonal coordinate axes similar to as those shown in FIGS. 1 to 3, are shown for convenience of description.

In the present embodiment, as in the examples of FIGS. 1 to 3, for convenience of description, it is assumed that the Z-axis direction is an upward/downward direction, the positive direction of the Z-axis is the upward direction, and the negative direction of the Z-axis is the downward direction. Also, in the present embodiment, for convenience of description, it is assumed that the Y-axis direction is a left/right direction, the positive direction of the Y-axis is the left direction and the negative direction of the Y-axis is the right direction. Also, in the present embodiment, for convenience of description, it is assumed that the direction of the X-axis is a depth direction, the positive direction of the X-axis is a backward direction and the negative direction of the X-axis is a forward direction.

The multi-axis antenna 401 includes a core portion M1 and a conductor A1.

In the present embodiment, the core portion M1 includes a magnetic core and an insulating member. The insulating member covers the magnetic core. Here, the core portion M1 may be configured without an insulating member.

Also, as another example of the configuration, the core portion M1 may be a bobbin such as a resin member. Also, although the core portion M1 is described as a physical object (the magnetic core and the insulating member) in the present embodiment, the core portion M1 may be an air core (a core of air), i.e., the conductor A1 may be provided in a space where a physical object such as a magnetic core is absent.

The core portion M1 has a cubic shape. In the example of FIG. 4, two faces facing each other among six faces of a cube are parallel to a YZ plane, other two faces facing each other are faces parallel to an XZ plane, and the other two faces facing each other are faces parallel to an XY plane.

In the present embodiment, the magnetic core constituting the core portion M1 has a cubic shape and the insulating member has a shape that covers the periphery of the cube.

In the present embodiment, for convenience of description, a direction from the center of the core portion M1 to each surface is defined as a direction from the inside to the outside and a direction from each surface of the core portion M1 to the center is defined as a direction from the outside to the inside.

Also, the magnetic core (a component of the core portion M1 in the present embodiment) may be made of, for example, one magnetic material, or may be made of a plurality of magnetic materials.

When the magnetic core is made of a plurality of magnetic materials, the shape (including a size) of each magnetic material may be any shape, for example, all the magnetic materials may have the same shape. Alternatively, some magnetic materials may have different shapes.

When the magnetic core M1 is configured using a plurality of magnetic materials, for example, the plurality of magnetic materials may be laminated in a direction of gravity. As will be described below, in the present embodiment, because the priority of detection of the magnetic field in the direction of gravity is low, a direction of the lamination as described above may be used. That is, the direction of the magnetic field having a high priority (a direction of a flow of a magnetic flux) may be different from a lamination direction of a plurality of magnetic materials in which there is a location where the magnetic materials are disconnected. As the plurality of magnetic materials to be laminated, for example, a magnetic material having a thin thickness in the lamination direction may be used.

In the present embodiment, the conductor A1 is a conducting wire having a linear shape. As a specific example, the conductor A1 is an enamel wire.

The conductor A1 is wound in a predetermined shape from a start point 411 to an end point 412.

Here, although a case in which the conductor A1 is wound from the start point 411 to the end point 412 will be described for convenience of description in the present embodiment, the conductor A1 may be processed in any way as long as the final shape is the same.

Here, the conductor A1 is configured using, for example, a metal wire. At least metal portions of the conductor A1 overlapping each other are insulated from each other. As a specific example, an insulation-coated conductor in which the metal wire is insulation-coated may be used as the metal wire constituting the conductor A1 and the entire conductor A1 may be insulated thereby. When an insulation-coated conductor is used as the metal wire constituting the conductor A1, adjacent insulation-coated conductors may be wound to be in contact with each other. Also, in the present embodiment, the contact between the insulation-coated conductors means that conductor portions of the insulation-coated conductors are not in contact with each other, but that insulating portions thereof are in contact with each other.

Also, in the present embodiment, in the multi-axis antenna 401, an insulating member may be provided between the magnetic core of the core portion M1 and the conductor A1. For example, an insulating member may be provided around the magnetic core even if the conductor A1 is an insulation-coated conductor and the state of insulation can be retained even if a part of the insulation-coated conductor is peeled off.

As described above, the multi-axis antenna 401 may include an insulating member with which the outer surface of the magnetic core is covered as in the present embodiment. For example, an insulating member with which the entire magnetic core is covered may be used as the insulating member, but an insulating member with which a part of the magnetic core is covered may be used as another example of the configuration.

Normally, it is not desirable to make direct contact between the conductor A1 constituting a winding wire and the magnetic material (the magnetic core of the core portion M1 in the present embodiment).

Although the conductor A1 is roughly divided into a first conducting wire 431, a second conducting wire 432, and a third conducting wire 433 for convenience of description in the example of FIG. 4, these are integrated in the state shown in FIG. 4. The first conducting wire 431, the second conducting wire 432, and the third conducting wire 433 are electrically connected to each other. Also, the first conducting wire 431, the second conducting wire 432, and the third conducting wire 433 may be connected in series in the order of, for example, the first conducting wire 431, the second conducting wire 432, and the third conducting wire 433 or may be connected in another order.

Likewise, although a case in which the winding portion formed by winding the conductor A1 is divided into a first winding portion 451 formed by winding the first conducting wire 431, a second winding portion 452 formed by winding the second conducting wire 432, and a third winding portion 453 formed by winding the third conducting wire 433 will be described for convenience of description in the example of FIG. 4, they are integrated in the state shown in FIG. 4. The first winding portion 451, the second winding portion 452, and the third winding portion 453 are electrically connected to each other. Also, the first winding portion 451, the second winding portion 452, and the third winding portion 453 may be connected in series in the order of, for example, the first winding portion 451, the second winding portion 452, and the third winding portion 453 or may be connected in another order.

As described above, the first conducting wire 431, the second conducting wire 432, and the third conducting wire 433 may be described separately for convenience of description in the present embodiment, but these are integrated in the state shown in FIG. 4 and there are no particular breaks therebetween. Likewise, the first winding portion 451, the second winding portion 452, and the third winding portion 453 may be described separately for convenience of description in the present embodiment, but these are integrated in the state shown in FIG. 4 and there are no particular breaks therebetween.

Although the first conducting wire 431 of the first winding portion 451, the second conducting wire 432 of the second winding portion 452, and the third conducting wire 433 of the third winding portion 453 are connected continuously in one wire in the present embodiment, one or more of the above wires may be separately configured and then electrically connected to the other wires as another example of the configuration. Also, a wire formed by electrically connecting two or more separate wires may be used as each of one or more of the above wires.

The first conducting wire 431 of the first winding portion 451, the second conducting wire 432 of the second winding portion 452, and the third conducting wire 433 of the third winding portion 453 are wound around the core portion M1.

Also, when an insulating member with which the outer surface of the magnetic core is covered is provided in the multi-axis antenna 401 as in the present embodiment, the first winding portion 451, the second winding portion 452, and the third winding portion 453 are wound around a magnetic core via the insulating member.

The first winding portion 451 is a portion having the highest priority and is a portion where the first conducting wire 431 is initially wound from the start point 411.

The first winding portion 451 is a portion where the first conducting wire 431 is wound around an axis (the first winding axis in the example of FIG. 4) parallel to the X-axis and passing through the center of the core portion M1 along the four surfaces of the core portion M1 around the axis.

The second winding portion 452 is a portion having the second highest priority and is a portion where the second conducting wire 432 is wound after the first winding portion 451.

The second winding portion 452 is a portion where the second conducting wire 432 is wound around an axis (the second winding axis in the example of FIG. 4) parallel to the Y-axis and passing through the center of the core portion M1 along the four surfaces of the core portion M1 around the axis.

The third winding portion 453 is a portion having the third highest priority and is a portion where the third conducting wire 433 is wound after the second winding portion 452. The third winding portion 453 is connected to the end point 412.

The third winding portion 453 is a portion where the third conducting wire 433 is wound around an axis parallel to the Z-axis (an axis parallel to a direction of gravity) and passing through the center of the core portion M1 (the third winding axis in the example of FIG. 4) along the four surfaces of the core portion M1 around the axis.

Here, in the first winding portion 451, the first conducting wire 431 is wound a plurality of times at equal intervals. The equal intervals may be substantially equal intervals in part or in whole.

The first conducting wire 431 of the end portion of the first winding portion 451 is changed from the winding direction of the first winding portion 451 to the winding direction of the second winding portion 452 and is connected to the second conducting wire 432 of the start portion of the second winding portion 452.

In the second winding portion 452, the second conducting wire 432 is wound a plurality of times at equal intervals. The equal intervals may be substantially equal intervals in part or in whole.

The second conducting wire 432 of the end portion of the second winding portion 452 is changed from the winding direction of the second winding portion 452 to the winding direction of the third winding portion 453 and is connected to the third conducting wire 433 of the start portion of the third winding portion 453.

In the third winding portion 453, the third conducting wire 433 is wound a plurality of times at equal intervals. The equal intervals may be substantially equal intervals in part or in whole.

Also, in the multi-axis antenna 401, for example, a guide for winding the conductor A1 is provided for one or more of the first winding portion 451, the second winding portion 452, and the third winding portion 453 and the conductor A1 may be wound using the guide. Also, the above guide may be provided for a part of each of the first winding portion 451, the second winding portion 452, and the third winding portion 453.

Here, the axial direction of the first winding axis of the first winding portion 451 and the axial direction of the second winding axis of the second winding portion 452 are two different directions that intersect. In the present embodiment, the above two directions are orthogonal to each other. Also, the above two directions are directions orthogonal to the direction of gravity. Also, instead of orthogonality, substantial orthogonality may be used.

Also, the axial direction of the third winding axis of the third winding portion 453 is a different direction intersecting the axial direction of the first winding axis of the first winding portion 451 and the axial direction of the second winding axis of the second winding portion 452. Also, the axial direction of the third winding axis of the third winding portion 453 is a direction parallel to the direction of gravity. In the present embodiment, the above three directions are orthogonal to each other. That is, the axial direction of the third winding axis of the third winding portion 453 is perpendicular to the axial direction of the first winding axis of the first winding portion 451 and the axial direction of the second winding axis of the second winding portion 452. Also, instead of orthogonality (or perpendicularity), substantial orthogonality (or substantial perpendicularity) may be used.

As described above, the axial direction of the first winding axis of the first winding portion 451, the axial direction of the second winding axis of the second winding portion 452, and the axial direction of the third winding axis of the third winding portion 453 are three different directions that intersect each other.

Although a configuration in which the axial direction of the first winding axis of the first winding portion 451, the axial direction of the second winding axis of the second winding portion 452, and the axial direction of the third winding axis of the third winding portion 453 intersect each other is shown in the present embodiment, a configuration in which any one of the above three axial directions does not intersect the other two axial directions may be used, or a configuration in which all the above three axial directions do not intersect each other may be used, as another example of the configuration. Here, in the present embodiment, the fact that the axial direction of the winding axis of one winding portion and the axial direction of the winding axis of the other winding portion do not intersect means that the center of the one winding portion and the center of the other winding portion deviate.

As an example of a method of winding the conductor A1, there is a winding method of winding the conductor A1 five times in a first direction, winding the conductor A1 five times in a second direction after the direction is changed by 90 degrees, and winding the conductor A1 five times in a third direction after the direction is changed by 90 degrees. The number of windings may be another number.

As another example of a method of winding the conductor A1, there is a winding method of winding the conductor A1 three times in the first direction, winding the conductor A1 in the second and third directions after changing the direction, and winding the conductor A1 two times in the first direction. The number of windings may be another number.

Also, in each of the first winding portion 451, the second winding portion 452, and the third winding portion 453, the number of times that the conductor A1 overlaps and is wound at the same position may be arbitrary. For example, each of the first winding portion 451, the second winding portion 452, and the third winding portion 453 may be a single winding portion, a double winding portion, or a triple or more winding portion.

The first conducting wire 431 of the first winding portion 451 and the third conducting wire 433 of the third winding portion 453 have a portion (a first part) where these overlap each other. The portion is disposed in the order of the first conducting wire 431 of the first winding portion 451 and the third conducting wire 433 of the third winding portion 453 from the center of the multi-axis antenna 401 to the outside.

The first conducting wire 431 of the first winding portion 451 is disposed inside the third conducting wire 433 of the third winding portion 453 and therefore the characteristics of the antenna of the first conducting wire 431 of the first winding portion 451 are higher than the characteristics of the antenna of the third conducting wire 433 of the third winding portion 453. As described above, in the present embodiment, the characteristics of the antenna of the first winding portion 451 are prioritized as compared with the characteristics of the antenna of the third winding portion 453.

Also, in accordance with the overall winding method for the conductor A1 and the like, the above arrangement may be applied to, for example, a part (for example, a great part) of the whole of the first winding portion 451 and the third winding portion 453, and a configuration in which the other part is different may be used.

Here, normally, when a gap is formed between the magnetic core and the conductor A1, the antenna sensitivity of the winding portion including the portion of the conductor A1 in which the gap is formed is less than that when the gap is absent or smaller. For this reason, it may be one example of the configuration to wind around a position close to the inside of the magnetic core so that a gap is not formed between the winding portion to be prioritized and the magnetic core as much as possible, for example, there may be no (or few) other conductors inside the winding portion to be prioritized.

The second conducting wire 432 of the second winding portion 452 and the third conducting wire 433 of the third winding portion 453 have a portion (a second portion) where these overlap each other. The portion is disposed in the order of the second conducting wire 432 of the second winding portion 452 and the third conducting wire 433 of the third winding portion 453 from the center of the multi-axis antenna 401 to the outside.

The second conducting wire 432 of the second winding portion 452 is disposed inside the third conducting wire 433 of the third winding portion 453 and therefore the characteristics of the antenna of the second conducting wire 432 of the second winding portion 452 are higher than the characteristics of the antenna by the third conducting wire 433 of the third winding portion 453. As described above, in the present embodiment, the characteristics of the antenna of the second winding portion 452 are prioritized as compared with the characteristics of the antenna of the third winding portion 453.

Also, in accordance with the overall winding method for the conductor A1 and the like, the above arrangement may be applied to, for example, a part (for example, a great part) of the whole of the second winding portion 452 and the third winding portion 453, and a configuration in which the other part is different may be used.

The first conducting wire 431 of the first winding portion 451 and the second conducting wire 432 of the second winding portion 452 have a portion (a third portion) where these overlap each other. The portion is disposed in the order of the first conducting wire 431 of the first winding portion 451 and the second conducting wire 432 of the second winding portion 452 from the center of the multi-axis antenna 401 to the outside.

The first conducting wire 431 of the first winding portion 451 is disposed inside the second conducting wire 432 of the second winding portion 452 and therefore the characteristics of the antenna of the first conducting wire 431 of the first winding portion 451 are higher than the characteristics of the antenna of the second conducting wire 432 of the second winding portion 452. As described above, in the present embodiment, the characteristics of the antenna of the first winding portion 451 are prioritized as compared with the characteristics of the antenna of the second winding portion 452.

Also, in accordance with the overall winding method for the conductor A1 and the like, the above arrangement may be applied to, for example, a part (for example, a great) of the whole of the first winding portion 451 and the second winding portion 452, and a configuration in which the other part is different may be used.

Here, although the appearance of the conductor A1 provided on three of the six surfaces of the core portion M1 is shown in the example of FIG. 4, the appearance of the other three surfaces is also roughly similar.

FIG. 5 is a diagram showing a schematic configuration of a bent portion 471 in the multi-axis antenna 401 according to the embodiment (the first embodiment).

In FIG. 5, for convenience of description, XYZ coordinate axes that are the same as those in FIG. 4 are shown in a different direction.

In the example of FIG. 5, the bent portion 471 at the portion where the first conducting wire 431 of the end portion of the first winding portion 451 and the second conducting wire 432 of the start portion of the second winding portion 452 are connected is shown.

Here, in the example of FIG. 5, for the simplification of illustration, the illustration of the third winding portion 453 is omitted.

Also, for example, directions of XYZ coordinate axes are different, but bending similar to that of the bent portion 471 shown in FIG. 5 is formed, with respect to the bent portion at the portion where the second conducting wire 432 of the end portion of the second winding portion 452 and the third conducting wire 433 of the start portion of the third winding portion 453 are connected.

In the bent portion 471, the first conducting wire 431 is bent so that the second conducting wire 432 is wound around an axis parallel to the Y-axis from a direction in which the first conducting wire 431 is wound around an axis parallel to the X-axis.

In the example of FIG. 5, the first conducting wire 431 is wound to be slightly returned in the positive direction of the Y-axis after being wound in the negative direction of the Y-axis and then wound in the positive direction of the X-axis, so that the first conducting wire 431 is formed in the winding direction of the second conducting wire 432. That is, the winding direction of the first conducting wire 431 is changed by 90 degrees and becomes the winding direction of the second conducting wire 432. The 90 degrees may be approximately 90 degrees.

As described above, in the example of FIG. 5, the conductor A1 is wound in the first direction, slightly returned from a position where it has gone a little too far, and then wound in the second direction after the direction is changed by 90 degrees. Thereby, when the conductor A1 is wound in the second direction, a first winding part is configured to be covered and pressed from the outside to the inside of the core portion M1.

According to the above configuration, in the bent portion 471, the start portion of the second conducting wire 432 presses the end portion of the first conducting wire 431 from the outside to the inside of the core portion M1 at a location where there is a change from the winding direction of the first conducting wire 431 to the winding direction of the second conducting wire 432. Thereby, in the multi-axis antenna 401, it is possible to ensure that the shape of the conductor A1 is maintained.

Here, the bent portion 471 shown in FIG. 5 is an example and the present disclosure is not limited to the example of FIG. 5. Any winding form may be used by making a change from the winding direction of the first conducting wire 431 to the winding direction of the second conducting wire 432 for the conductor A1.

As described above, the multi-axis antenna 401 according to the present embodiment includes winding portions of a plurality of winding axes intersecting each other (the first winding portion 451, the second winding portion 452, and the third winding portion 453) and can reduce an influence of the zero point (for example, eliminate the zero point) for the whole of the plurality of winding portions and improve the characteristics of the antenna.

### <Application of Multi-Axis Antenna to Antenna in Position Detection System>

The multi-axis antenna 401 may be used as, for example, a transmission antenna or a reception antenna.

Also, the multi-axis antenna 401 is configured as, for example, an LF band antenna.

When the multi-axis antenna 401 is used as the transmission antenna, an AC power supply is connected to the start point 411 and the end point 412 of the conductor A1 of the multi-axis antenna 401. That is, the electric power supplied from the AC power supply causes an electric current to flow from the start point 411 to the end point 412 of the conductor A1. Thereby, a magnetic field is generated from the multi-axis antenna 401 and the magnetic field can be applied to the reception antenna due to the magnetic field. The communication performed by the magnetic field may be, for example, communication using a single frequency or communication using a plurality of frequencies (a continuous frequency band or discrete frequencies).

When the multi-axis antenna 401 is used as a reception antenna, an electric current flows between the start point 411 and the end point 412 of the conductor A1 of the multi-axis antenna 401 due to the magnetic field generated from the transmission antenna. The communication performed by the magnetic field may be, for example, communication using a single frequency or communication using a plurality of frequencies (a continuous frequency band or discrete frequencies).

Specifically, in the example of FIG. 2, a multi-axis antenna similar to the multi-axis antenna 401 is used as all the antennas of the transmission antenna 51 and the four reception antennas 31 to 34.

Also, as another example of the configuration, in the example of FIG. 2, a multi-axis antenna similar to the multi-axis antenna 401 is used as a part of one or more of the transmission antenna 51 and the four reception antennas 31 to 34. For example, a multi-axis antenna similar to the multi-axis antenna 401 may be used for all of the four reception antennas 31 to 34.

Also, specifically, in the example of FIG. 3, a multi-axis antenna similar to the multi-axis antenna 401 is used as all the antennas of the two transmission antennas 201 and 202 and the four reception antennas 31 to 34.

Also, as another example of the configuration, in the example of FIG. 3, a multi-axis antenna similar to the multi-axis antenna 401 may be used as a part of one or more of the two transmission antennas 201 and 202 and the four reception antennas 31 to 34. For example, a multi-axis antenna similar to the multi-axis antenna 401 may be used for all of the two transmission antennas 201 and 202. Also, for example, a multi-axis antenna similar to the multi-axis antenna 401 may be used for all of the four reception antennas 31 to 34.

As described above, when a plurality of antennas are provided in the position detection system, for example, the number of antennas to which multi-axis antennas similar to the multi-axis antenna 401 are applied may be large and a configuration in which multi-axis antennas similar to the multi-axis antenna 401 are applied to all antennas may be used.

Also, when a plurality of antennas are provided in the position detection system, for example, any antenna such as a bar antenna may be used for an antenna to which a multi-axis antenna similar to the multi-axis antenna 401 is not applied.

Also, when a multi-axis antenna similar to the multi-axis antenna 401 is used as the antenna shown in FIG. 2 or 3, it may be one example of the configuration to align and dispose the XYZ coordinate axes shown in FIG. 4 and the XYZ coordinate axes shown in FIG. 2 or 3.

That is, the first winding portion 451 wound around an axis (a first winding axis) of a direction (a direction parallel to the X-axis) which is perpendicular to a direction (a direction parallel to the Y-axis) parallel to the traveling direction of the vehicle (the electric vehicle EV in the present embodiment) and is not a direction of gravity (a direction parallel to the Z-axis) has the highest priority and makes wireless communication between the transmission antenna and the reception antenna more efficient.

Also, in the present embodiment, the second winding portion 452 wound around an axis (a second winding axis) which is an axis other than the first winding axis and is in a direction (the direction parallel to the Y-axis) which is not the direction of gravity (the direction parallel to the Z-axis) has the second highest priority.

In the present embodiment, as a form of the arrangement of the multi-axis antenna used as the transmission antenna or the reception antenna, the first winding portion 451 for which the axial direction of the winding axis of the winding portion of the multi-axis antenna similar to the multi-axis antenna 401 is orthogonal to the traveling direction of the vehicle and orthogonal to the direction of gravity has the highest priority.

Here, the reason why the first winding portion 451 has the highest priority in the present embodiment will be described. That is, because a distance required for the position detection in the traveling direction of the vehicle including the electric vehicle EV is longer than a distance required for the position detection in the width direction of the vehicle in the position detection system for the wireless power transmission system 1 according to the present embodiment, it may be one example of the configuration to ensure the strength of radio waves in the traveling direction of the vehicle. Thus, in the position detection system, according to a configuration in which the first winding portion 451 for which the axial direction of the winding axis of the winding portion is orthogonal to the traveling direction of the vehicle and orthogonal to the direction of gravity is prioritized, radio waves propagating in the traveling direction of the vehicle can be strongly ensured and the configuration is effective. The above is also true for, for example, the position detection system of the wireless power transmission system of a vehicle other than the electric vehicle EV according to the present embodiment.

Also, when a plurality of antennas are provided in the position detection system and multi-axis antennas similar to the multi-axis antenna 401 are used as two or more of the plurality of antennas, a configuration in which winding directions of the multi-axis antennas are disposed to be the same with respect to the two or more antennas may be used.

As described above, when a plurality of multi-axis antennas are provided on the transmission side or the reception side of the position detection system, a configuration in which directions of arrangements of the plurality of multi-axis antennas are the same may be used. However, even if the arrangements of some of the plurality of multi-axis antennas described above is different from the other arrangements, the detection of a position (for example, the calculation of a position using an arithmetic expression) is enabled, for example, when information according to a method of the arrangement of each multi-axis antenna (for example, an arithmetic expression or the like) is set.

Also, when the position is detected in the position detection system, a multi-axis antenna is disposed so that the winding direction is the same as a reference winding direction when the reference winding direction is determined for the winding direction of the multi-axis antenna. That is, when the position is detected by comparing the detection result of the multi-axis antenna disposed in the position detection system with the detection result of the multi-axis antenna in the reference winding direction, the winding direction of the multi-axis antenna may be identical to the reference winding direction.

Also, in the configuration of the multi-axis antenna 401 according to the present embodiment, because the first winding portion 451, the second winding portion 452, and the third winding portion 453 roughly have a symmetrical configuration, a symmetrical arrangement with respect to the example of FIG. 4 may be used when these are applied to a transmission antenna or a reception antenna.

Also, when a plurality of antennas are provided in the position detection system and multi-axis antennas are used as two or more antennas among the plurality of antennas, it may be one example of the configuration to use multi-axis antennas having the same configuration for the two or more antennas, but multi-axis antennas having different configurations may be included as another example of the configuration.

As a specific example, the wireless power transmission system 1 includes a plurality of transmission antennas. The plurality of transmission antennas are disposed apart from each other within a surface parallel to a surface of one coil (a coil surface) for which a transmission antenna is provided within the power transmission coil L1 of the wireless power transmission device 10 and the power reception coil L2 of the wireless power reception device 20. Also, the plurality of transmission antennas described above are multi-axis antennas (multi-axis antennas similar to the multi-axis antenna 401 in the present embodiment), and the winding directions of the conducting wires thereof are the same as each other.

Here, in the present embodiment, the coil surface of the coil formed by winding the conductor is a virtual surface determined by the conducting wire and an opening at each of both ends of the winding axis of the coil in the axial direction. The opening represents an inner portion surrounded by the conducting wire and both ends in the axial direction of the winding axis of the coil are two ends at which the conducting wire exists in the axial direction. Also, the arrangement of the conductors wound in real coils is likely to deviate from the ideal arrangement. In this case, the coil surface of the coil may also be appropriately regarded as a surface deviating from the ideal surface.

As a specific example, the wireless power transmission system 1 includes a plurality of reception antennas. The plurality of reception antennas are disposed apart from each other within a surface parallel to a surface of one coil (a coil surface) for which a reception antenna is provided within the power transmission coil L1 of the wireless power transmission device 10 and the power reception coil L2 of the wireless power reception device 20. Also, the plurality of reception antennas described above are multi-axis antennas (multi-axis antennas similar to the multi-axis antenna 401 in the present embodiment), and the winding directions of the conducting wires thereof are the same as each other.

As described above, in the multi-axis antenna 401 according to the present embodiment, the conductor A1 is wound around a plurality of different axes in the core portion M1 and the antenna is almost omnidirectional as a whole. The multi-axis antenna 401 according to the present embodiment is applied to one or more of the plurality of antennas when position detection is performed using the transmission side antenna and the reception side antenna.

Therefore, in the multi-axis antenna 401 according to the present embodiment, the position can be detected with high accuracy when the position is detected using the transmission side antenna and the reception side antenna.

For example, the multi-axis antenna 401 according to the present embodiment can mitigate the influence of the zero point and improve the accuracy of position detection even if a configuration for switching a plurality of antennas using a switch is not used as compared with the single-axis antenna.

In the multi-axis antenna 401 according to the present embodiment, for example, the conductor A1 is wound around a plurality of different axes in the core portion M1 and the overall volume of the antenna can be limited to a small volume.

In the position detection system in the wireless power transmission system 1 according to the present embodiment, when electric power is wirelessly transmitted from the power transmission coil L1 of the wireless power transmission device 10 to the power reception coil L2 of the wireless power reception device 20, the relative positions of the power transmission side and the power reception side are detected using one or more multi-axis antennas (multi-axis antennas similar to the multi-axis antenna 401) as one or both of the transmission antenna and the reception antenna.

Therefore, in the position detection system in the wireless power transmission system 1 according to the present embodiment, when position detection is performed using the transmission side antenna and the reception side antenna, it is possible to limit a decrease in transmission strength of the antenna of the transmission side or a decrease in reception strength of the antenna of the reception side using the multi-axis antenna.

Here, although the configuration in which the reception antenna is provided in the wireless power transmission device 10 and the transmission antenna is provided in the wireless power reception device 20 is shown in the present embodiment, the transmission antenna is provided in the wireless power transmission device 10 and the reception antenna is provided in the wireless power reception device 20 as another example of the configuration. Also, as another example of the configuration, a wireless power transmission device and a wireless power reception device to which both of the above configurations are applied may be implemented.

In the position detection system, one transmission antenna may be provided or two or more transmission antennas may be provided.

In the position detection system, one reception antenna may be provided or two or more reception antennas may be provided.

### Modified Examples

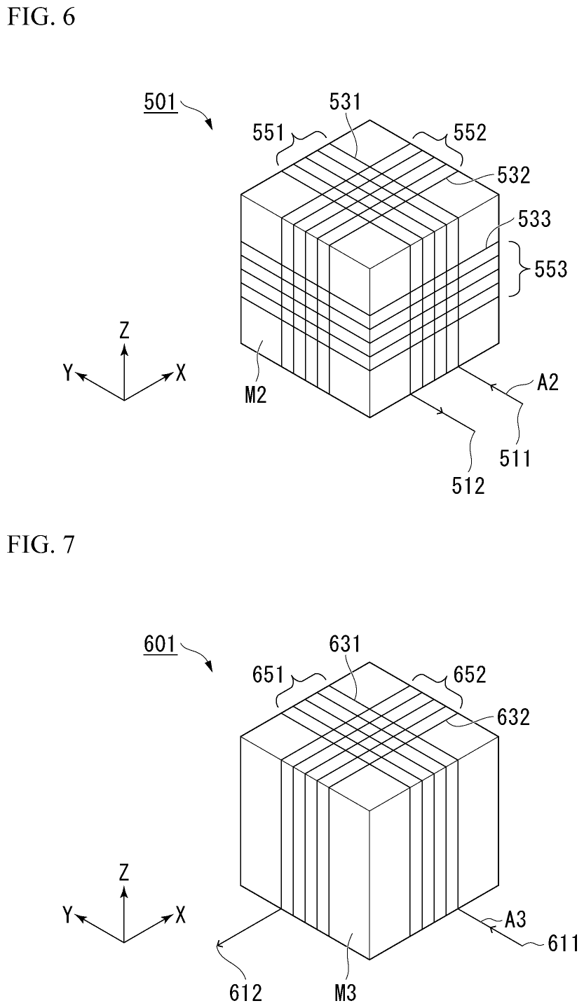

FIG. 6 is a diagram showing a schematic configuration of a multi-axis antenna 501 according to a modified example of the embodiment (the first embodiment).

In FIG. 6, XYZ coordinate axes that are the same as those shown in FIG. 4 are shown for convenience of description.

In FIG. 6, a core portion M2 and a conductor A2 constituting the multi-axis antenna 501 are shown.

The conductor A2 includes a first winding portion 551 around which a first conducting wire 531 is wound, a second winding portion 552 around which a second conducting wire 532 is wound, and a third winding portion 553 around which a third conducting wire 533 is wound.

Also, a conductor A1 is wound from a start point 511 to an end point 512.

Here, the configuration of the multi-axis antenna 501 according to the modified example is different from the configuration of the multi-axis antenna 401 shown in FIG. 4 in that the conductor A2 is wound so that the start point 511 and the end point 512 are disposed on the same surface of the core portion M2 and the above configurations are similar in others.

That is, in the multi-axis antenna 501 according to the modified example, the conductor A2 is wound from the start point 511 in the order of the first winding portion 551, the second winding portion 552, and the third winding portion 553 and is finally wound around the first winding portion 551 again to reach the end point 512.

As described above, a configuration in which the conductor A2 is started to be wound from the first direction and the tip of the start of winding and the tip of the end of winding are disposed on the same surface may be adopted in the multi-axis antenna 501.

The multi-axis antenna 501 according to the modified example is particularly effective, for example, when a connection destination (for example, a transmission side line or a reception side line) of the start point 511 and the end point 512 of the conductor A2 is provided at a nearby position such as the same surface.

### Second Embodiment

FIG. 7 is a diagram showing a schematic configuration of a multi-axis antenna 601 according to an embodiment (a second embodiment).

In FIG. 7, XYZ coordinate axes that are the same as those shown in FIG. 4 are shown for convenience of description.

In FIG. 7, a core portion M3 and a conductor A3 constituting the multi-axis antenna 601 are shown.

The conductor A3 includes a first winding portion 651 around which the first conducting wire 631 is wound and a second winding portion 652 around which the second conducting wire 632 is wound.

Also, the conductor A3 is wound from a start point 611 to an end point 612.

Here, the configuration of the multi-axis antenna 601 is different from the configuration of the multi-axis antenna 401 shown in FIG. 4 in that a third winding portion having the lowest priority (the third winding portion 453 in the example of FIG. 4) is not provided and these are similar in others.

As described above, the multi-axis antenna 601 according to the present embodiment includes winding portions (the first winding portion 651 and the second winding portion 652) of a plurality of winding axes that intersect each other and can reduce the influence of the zero point (for example, eliminate the zero point) as a whole of the plurality of winding portions and improve the characteristics of the antenna.

### Third Embodiment

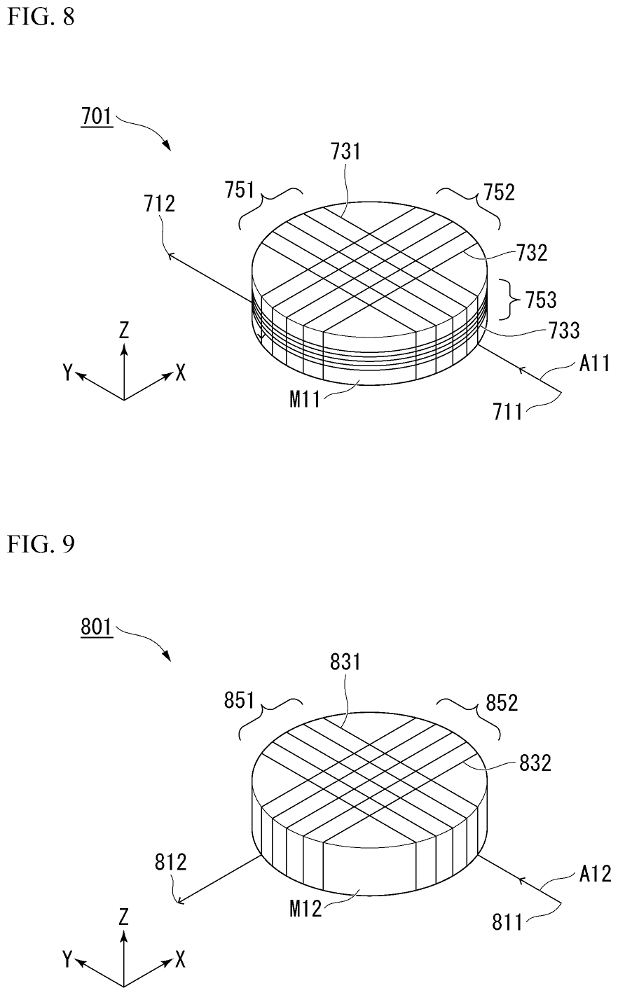

FIG. 8 is a diagram showing a schematic configuration of a multi-axis antenna 701 according to an embodiment (a third embodiment).

In FIG. 8, XYZ coordinate axes that are same as those shown in FIG. 4 are shown for convenience of description.

In FIG. 8, a core portion M11 and a conductor A11 constituting the multi-axis antenna 701 are shown.

The conductor A11 includes a first winding portion 751 around which the first conducting wire 731 is wound, a second winding portion 752 around which the second conducting wire 732 is wound, and a third winding portion 753 around which the third conducting wire 733 is wound.

Also, the conductor A11 is wound from a start point 711 to an end point 712.

Here, the configuration of the multi-axis antenna 701 is different from the configuration of the multi-axis antenna 401 shown in FIG. 4 in the shape of the core portion M11 and the shape in which the conductor A11 is wound and these are similar in others.

The core portion M11 has a cylindrical shape. In the example of FIG. 8, two circular surfaces of the core portion M11 are surfaces parallel to an XY plane and a height direction of a cylinder becomes a direction parallel to a Z-axis.

The first winding portion 751 is wound across two circular surfaces and a side surface of the cylinder.

The second winding portion 752 is wound across two circular surfaces and a side surface of the cylinder.

The third winding portion 753 is wound in a circumferential direction of the side surface of the cylinder.

Here, the first winding portion 751 is wound in a substantially rectangular shape, the second winding portion 752 is wound in a substantially rectangular shape, and the third winding portion 753 is wound in a circular shape.

As described above, the multi-axis antenna 701 according to the present embodiment includes winding portions (the first winding portion 751, the second winding portion 752, and the third winding portion 753) of a plurality of winding axes that intersect each other and can reduce the influence of the zero point (for example, eliminate the zero point) as a whole of the plurality of winding portions and improve the characteristics of the antenna.

### Fourth Embodiment

FIG. 9 is a diagram showing a schematic configuration of a multi-axis antenna 801 according to an embodiment (a fourth embodiment).

In FIG. 9, XYZ coordinate axes that are the same as those shown in FIG. 8 are shown for convenience of description.

In FIG. 9, a core portion M12 and a conductor A12 constituting the multi-axis antenna 801 are shown.

The conductor A12 includes a first winding portion 851 around which a first conducting wire 831 is wound and a second winding portion 852 around which a second conducting wire 832 is wound.

Also, the conductor A12 is wound from a start point 811 to an end point 812.

Here, the configuration of the multi-axis antenna 801 is different from the configuration of the multi-axis antenna 701 shown in FIG. 8 in that the third winding portion having the lowest priority (the third winding portion 753 in the example of FIG. 8) is not provided and these are similar in others.

As described above, the multi-axis antenna 801 according to the present embodiment has winding portions (the first winding portion 851 and the second winding portion 852) of a plurality of winding axes that intersect each other and can reduce the influence of the zero point (for example, eliminate the zero point) as a whole of the plurality of winding portions and improve the characteristics of the antenna.

### (Regarding Above Embodiments)

In the above embodiments, a cubic shape and a cylindrical shape are used as the shape of the core portion of the multi-axis antenna (for example, the shape of a magnetic core or a bobbin), but other shapes may be used. For example, the shape of a rectangular parallelepiped, the shape of another polyhedron, the shape of a sphere, or the like other than a cube may be used as the shape of the core portion of the multi-axis antenna.

### <Examples of Configuration>

As an example of the configuration, a position detection system for a wireless power transmission system (the wireless power transmission system 1 in the example of FIG. 1) for wirelessly transmitting electric power from a power transmission coil (the power transmission coil L1 in the example of FIG. 1) of a wireless power transmission device (the wireless power transmission device 10 in the example of FIG. 1) to a power reception coil (the power reception coil L2 in the example of FIG. 1) of a wireless power reception device (the wireless power reception device 20 in the example of FIG. 1) is configured as follows.

The position detection system includes at least one transmission antenna (the transmission antenna 51 in the examples of FIGS. 1 and 2 and the transmission antennas 201 and 202 in the example of FIG. 3) provided in one of the wireless power transmission device and the wireless power reception device and configured to transmit radio waves; at least one reception antenna (the reception antennas 31 to 34 in the examples of FIGS. 1 to 3) provided in the other of the wireless power transmission device and the wireless power reception device and configured to receive the radio waves; a radio wave detection unit (the radio wave detection unit 41 in the example of FIG. 1) configured to detect strength of the radio waves received by the reception antenna, and a position detection unit (the position detection unit 42 in the example of FIG. 1) configured to detect the relative position between the power transmission coil and the power reception coil on the basis of the strength detected by the radio wave detection unit.

At least one of the transmission antenna and the reception antenna is a multi-axis antenna (the multi-axis antennas 401, 501, 601, 701, and 801 in the examples of FIGS. 4 to 9) including a first winding portion (the first winding portions 451, 551, 651, 751, and 851 in the examples of FIGS. 4 to 9) formed by winding a first conducting wire (the first conducting wires 431, 531, 631, 731, and 831 in the examples of FIGS. 4 to 9) and a second winding portion (the second winding portions 452, 552, 652, 752, and 852 in the examples of FIGS. 4 to 9) formed by winding a second conducting wire (the second conducting wires 432, 532, 632, 732, and 832 in the examples of FIGS. 4 to 9).

An axial direction of a first winding axis of the first winding portion and an axial direction of a second winding axis of the second winding portion are two different directions.

The first winding portion and the second winding portion are electrically connected to each other.

As an example of the configuration, in the position detection system, the multi-axis antenna includes a magnetic core (the components of the core portions M1 to M3 and M11 to M12 in the example of FIGS. 4 to 9). The first conducting wire of the first winding portion and the second conducting wire of the second winding portion are wound around the magnetic core.

As an example of the configuration, the position detection system further includes an insulating member (the components of the core portions M1 to M3 and M11 to M12 in the example of FIGS. 4 to 9) with which an outer surface of the magnetic core is covered. The first winding portion and the second winding portion are wound around the magnetic core via the insulating member.

As an example of the configuration, in the position detection system, the magnetic core includes a plurality of magnetic materials.

As an example of the configuration, in the position detection system, the axial direction of the first winding axis of the first winding portion and the axial direction of the second winding axis of the second winding portion are orthogonal to a direction of gravity.

As an example of the configuration, the position detection system has the following configurations.

The multi-axis antenna further includes a third winding portion (the third winding portions 453, 553, and 753 in the examples of FIGS. 4 to 9) formed by winding a third conducting wire (the third conducting wires 433, 533, and 733 in the examples of FIGS. 4 to 9).

The axial direction of the first winding axis of the first winding portion, the axial direction of the second winding axis of the second winding portion, and an axial direction of a third winding axis of the third winding portion are three different directions.

The first winding portion, the second winding portion, and the third winding portion are electrically connected to each other.

As an example of the configuration, in the position detection system, the first conducting wire of the first winding portion and the third conducting wire of the third winding portion have a first part in which the first and the third conducting wires overlap each other. The second conducting wire of the second winding portion and the third conducting wire of the third winding portion have a second part in which the second and the third conducting wires overlap each other. The first part is disposed in the order of the first conducting wire of the first winding portion and the third conducting wire of the third winding portion from a center of the multi-axis antenna to an outside. The second part is disposed in the order of the second conducting wire of the second winding portion and the third conducting wire of the third winding portion from the center of the multi-axis antenna to the outside.

As an example of the configuration, in the position detection system, the multi-axis antenna includes a magnetic core, and the first conducting wire of the first winding portion, the second conducting wire of the second winding portion, and the third conducting wire of the third winding portion are wound around the magnetic core.

As an example of the configuration, the position detection system further includes an insulating member with which an outer surface of the magnetic core is covered, wherein the first winding portion, the second winding portion, and the third winding portion are wound around the magnetic core via the insulating member.

As an example of the configuration, in the position detection system, the magnetic core includes a plurality of magnetic materials in the multi-axis antenna including the first winding portion, the second winding portion, and the third winding portion.

As an example of the configuration, in the position detection system, the plurality of magnetic materials are laminated in a direction of gravity.

As an example of the configuration, in the position detection system, an axial direction of the first winding axis of the first winding portion and an axial direction of the second winding axis of the second winding portion are directions orthogonal to the direction of gravity, and an axial direction of the third winding axis of the third winding portion is parallel to the direction of gravity.

As an example of the configuration, in the position detection system, the axial direction of the third winding axis of the third winding portion is parallel to a direction of gravity.

As an example of the configuration, in the position detection system, the axial direction of the first winding axis of the first winding portion and the axial direction of the second winding axis of the second winding portion are directions orthogonal to the direction of gravity.

As an example of the configuration, the position detection system has the following configurations.

The at least one transmission antenna comprises a plurality of transmission antennas. The plurality of transmission antennas are disposed apart from each other within a surface parallel to a surface of one coil provided in the transmission antenna between the power transmission coil of the wireless power transmission device and the power reception coil of the wireless power reception device.

As an example of the configuration, in the position detection system, the plurality of transmission antennas are multi-axis antennas and have winding directions of conducting wires which are the same as each other.

As an example of the configuration, the position detection system has the following configurations.

The position detection system includes a plurality of reception antennas. The plurality of reception antennas are disposed apart from each other within a surface parallel to a surface of one coil provided in the reception antenna between the power transmission coil of the wireless power transmission device and the power reception coil of the wireless power reception device.

As an example of the configuration, in the position detection system, the plurality of reception antennas are multi-axis antennas and have winding directions of conducting wires which are the same as each other.

As an example of the configuration, in the position detection system, the transmission antenna is configured to control the number of transmission pulses or a transmission pulse width and transmit unique information of the wireless power transmission device or the wireless power reception device.

As an example of the configuration, there is provided a wireless power transmission system including the above-described position detection system.

Also, a program for implementing the function of any component of any device such as the wireless power transmission device 10 or the wireless power reception device 20 described above may be recorded on a computer-readable recording medium and the program may be read and executed by a computer system. Also, the “computer system” used here may include an operating system (OS) or hardware such as peripheral devices.

Also, the “computer-readable recording medium” refers to a storage device such as a flexible disc, a magneto-optical disc, a read-only memory (ROM), a portable medium such as a compact disc-ROM (CD-ROM), and a hard disk embedded in the computer system. Furthermore, the “computer-readable recording medium” is assumed to include a medium that holds a program for a constant period of time, such as a volatile memory inside a computer system serving as a server or a client when the program is transmitted via a network such as the Internet or a communication circuit such as a telephone circuit.

For example, the volatile memory may be a random-access memory (RAM). For example, the recording medium may be a non-transitory storage medium.

Also, the above-described program may be transmitted from a computer system storing the program in a storage device or the like to another computer system via a transmission medium or by transmission waves in a transmission medium. Here, the “transmission medium” for transmitting the program refers to a medium having a function of transmitting information, as in a network such as the Internet or a communication circuit such as a telephone circuit.

Also, the above-described program may be a program for implementing some of the above-described functions. Further, the above-described program may be a so-called differential file capable of implementing the above-described function in combination with a program already recorded on the computer system. The differential file may be referred to as a differential program.

Also, the function of any component of any device such as the wireless power transmission device 10 or the wireless power reception device 20 described above may be implemented by a processor. For example, each process in the present embodiment may be implemented by a processor that operates on the basis of information of a program or the like and a computer-readable recording medium that stores information of a program or the like. Here, in the processor, for example, the function of each part may be implemented by individual hardware or the function of each part may be implemented by integrated hardware. For example, the processor may include hardware and the hardware may include at least one of a circuit that processes a digital signal and a circuit that processes an analog signal. For example, the processor may be configured using one or more circuit devices or/and one or more circuit elements mounted on a circuit board. An integrated circuit (IC) or the like may be used as the circuit device and a resistor, a capacitor, or the like may be used as the circuit element.

Here, the processor may be, for example, a CPU. However, the processor is not limited to the CPU and, for example, various types of processors such as a graphics processing unit (GPU) or a digital signal processor (DSP) may be used. Also, for example, the processor may be a hardware circuit based on an application specific integrated circuit (ASIC). Also, the processor may include, for example, a plurality of CPUs, or may include a hardware circuit of a plurality of ASICs. Also, the processor may include, for example, a combination of a plurality of CPUs and a hardware circuit including a plurality of ASICs. Also, the processor may include, for example, one or more of an amplifier circuit and a filter circuit for processing an analog signal and the like.

Although embodiments of the present disclosure have been described above with reference to the drawings, specific configurations are not limited to the embodiments and other designs and the like may also be included without departing from the scope of the present disclosure.

### EXPLANATION OF REFERENCES

1 Wireless power transmission system
10 Wireless power transmission device
11 Conversion circuit
12 Power transmission circuit
13 Power transmission coil unit
14 Control circuit
15 Power transmission side communication unit
20 Wireless power reception device
21 Power reception coil unit
22 Rectifying and smoothing circuit
23 Protection circuit
24 Control circuit
25 Power reception side communication unit
31 to 34 Reception antenna
40 Position control unit
41 Radio wave detection unit
42 Position detection unit
43 Storage unit
51, 201, 202 Transmission antenna
101 Region
401, 501, 601, 701, 801 Multi-axis antenna
411, 511, 611, 711, 811 Start point
412, 512, 612, 712, 812 End point
431, 531, 631, 731, 831 First conducting wire
432, 532, 632, 732, 832 Second conducting wire
433, 533, 733 Third conducting wire
451, 551, 651, 751, 851 First winding portion
452, 552, 652, 752, 852 Second winding portion
453, 553, 753 Third winding portion
471 Bent portion
A1 to A3, A11 to A12 Conductor
M1 to M3, M11, M12 Core portion
G Ground
L1 Power transmission coil
L2 Power reception coil
P Commercial power supply
EV Electric vehicle
Vload Load

What is claimed is:

1. A position detection system for a wireless power transmission system for wirelessly transmitting electric power from a power transmission coil of a wireless power transmission device to a power reception coil of a wireless power reception device, the position detection system comprising:
at least one transmission antenna provided in one of the wireless power transmission device and the wireless power reception device and configured to transmit radio waves;
at least one reception antenna provided in other of the wireless power transmission device and the wireless power reception device and configured to receive the radio waves;
a radio wave detection unit configured to detect strength of the radio waves received by the reception antenna, and
a position detection unit configured to detect a relative position between the power transmission coil and the power reception coil on a basis of the strength detected by the radio wave detection unit,
wherein at least one of the transmission antenna and the reception antenna is a multi-axis antenna including a first winding portion formed by winding a first conducting wire and a second winding portion formed by winding a second conducting wire,
wherein an axial direction of a first winding axis of the first winding portion and an axial direction of a second winding axis of the second winding portion are two different directions, and
wherein the first winding portion and the second winding portion are electrically connected to each other.

2. The position detection system according to claim 1,
wherein the multi-axis antenna includes a magnetic core, and
wherein the first conducting wire of the first winding portion and the second conducting wire of the second winding portion are wound around the magnetic core.

3. The position detection system according to claim 2, further comprising an insulating member with which an outer surface of the magnetic core is covered,
wherein the first winding portion and the second winding portion are wound around the magnetic core via the insulating member.

4. The position detection system according to claim 2, wherein the magnetic core includes a plurality of magnetic materials.

5. The position detection system according to claim 1, wherein the axial direction of the first winding axis of the first winding portion and the axial direction of the second winding axis of the second winding portion are orthogonal to a direction of gravity.

6. The position detection system according to claim 1,
wherein the multi-axis antenna further includes a third winding portion formed by winding a third conducting wire,
wherein the axial direction of the first winding axis of the first winding portion, the axial direction of the second winding axis of the second winding portion, and an axial direction of a third winding axis of the third winding portion are three different directions, and
wherein the first winding portion, the second winding portion, and the third winding portion are electrically connected to each other.

7. The position detection system according to claim 6,
wherein the first conducting wire of the first winding portion and the third conducting wire of the third winding portion have a first part in which the first and the third conducting wires overlap each other,
wherein the second conducting wire of the second winding portion and the third conducting wire of the third winding portion have a second part in which the second and the third conducting wires overlap each other,
wherein the first part is disposed in an order of the first conducting wire of the first winding portion and the third conducting wire of the third winding portion from a center of the multi-axis antenna to an outside, and
wherein the second part is disposed in an order of the second conducting wire of the second winding portion and the third conducting wire of the third winding portion from the center of the multi-axis antenna to the outside.

8. The position detection system according to claim 6,
wherein the multi-axis antenna includes a magnetic core, and
wherein the first conducting wire of the first winding portion, the second conducting wire of the second winding portion, and the third conducting wire of the third winding portion are wound around the magnetic core.

9. The position detection system according to claim 8, further comprising an insulating member with which an outer surface of the magnetic core is covered,
wherein the first winding portion, the second winding portion, and the third winding portion are wound around the magnetic core via the insulating member.

10. The position detection system according to claim 8, wherein the magnetic core includes a plurality of magnetic materials.

11. The position detection system according to claim 10, wherein the plurality of magnetic materials are laminated in a direction of gravity.

12. The position detection system according to claim 11,
wherein an axial direction of the first winding axis of the first winding portion and an axial direction of the second winding axis of the second winding portion are directions orthogonal to the direction of gravity, and
wherein an axial direction of the third winding axis of the third winding portion is parallel to the direction of gravity.

13. The position detection system according to claim 6, wherein the axial direction of the third winding axis of the third winding portion is parallel to a direction of gravity.

14. The position detection system according to claim 13, wherein the axial direction of the first winding axis of the first winding portion and the axial direction of the second winding axis of the second winding portion are directions orthogonal to the direction of gravity.

15. The position detection system according to claim 1,
wherein the at least one transmission antenna compres a plurality of transmission antennas, and
wherein the plurality of transmission antennas are disposed apart from each other within a surface parallel to a surface of one coil provided in the transmission antenna between the power transmission coil of the wireless power transmission device and the power reception coil of the wireless power reception device.

16. The position detection system according to claim 15, wherein the plurality of transmission antennas are multi-axis antennas and have winding directions of conducting wires which are the same as each other.

17. The position detection system according to claim 1, comprising a plurality of reception antennas,
wherein the plurality of reception antennas are disposed apart from each other within a surface parallel to a surface of one coil provided in the reception antenna between the power transmission coil of the wireless power transmission device and the power reception coil of the wireless power reception device.

18. The position detection system according to claim 17, wherein the plurality of reception antennas are multi-axis antennas and have winding directions of conducting wires which are the same as each other.

19. The position detection system according to claim 1, wherein the transmission antenna is configured to control the number of transmission pulses or a transmission pulse width and transmit unique information of the wireless power transmission device or the wireless power reception device.

20. A wireless power transmission system comprising the position detection system according to claim 1.
